(19) United States
(12) Patent Application Publication
(10) Pub. No.: US 2026/0288034 A1
(43) Pub. Date: Sep. 24, 2026

(54) SUBSTRATE UNIT AND IMAGE FORMING APPARATUS

(71) Applicant: CANON KABUSHIKI KAISHA, Tokyo (JP)

(72) Inventors: JUNJI SUZUKI, Kanagawa (JP); AKIRA TATSUZUE, Saitama (JP); MASAMICHI IIDA, Kanagawa (JP); YUJI ITAKURA, Tokyo (JP); HIROSHI FUSE, Tokyo (JP); TAKUYA MIYASHITA, Kanagawa (JP)

(21) Appl. No.: 19/566,240

(22) Filed: Mar. 13, 2026

(30) Foreign Application Priority Data
Mar. 18, 2025 (JP) 2025-044032

(51) Int. Cl. G03G 15/08; G01F 23/292; G03G 15/00; G03G 21/16

(52) U.S. Cl. CPC G03G 15/0862; G01F 23/292; G03G 15/556; G03G 21/1647

(57) ABSTRACT

A substrate unit includes a sensor configured to output a signal that corresponds to an amount of toner stored in a storage portion configured to store the toner, a substrate including the sensor, the substrate being provided with a hole, a holder including a boss configured to be inserted into the hole, the holder being configured to hold the substrate, and a push nut configured to position the substrate with respect to the holder. The push nut engages with the boss such that the substrate is disposed between the holder and the push nut.

### BACKGROUND

### Field of the Technology

The present disclosure relates to a substrate unit that includes a sensor that outputs an output value corresponding to the amount of toner, and to an image forming apparatus that includes the substrate unit.

### Description of the Related Art

In general, in an electrophotographic image forming apparatus, an electrostatic latent image formed on the surface of a photosensitive drum is developed by using toner that serves as developer.

Japanese Patent Application Publication No. 2023-78633 discusses an image forming apparatus that detects the amount of toner stored in a developing unit by using a light emitting element and a light receiving element. Japanese Patent Application Publication No. 2023-78633 discusses a configuration in which the light emitting element and the light receiving element are disposed on the same surface of a substrate, and which includes a holder to which the substrate is attached.

In the image forming apparatus discussed in Japanese Patent Application Publication No. 2023-78633, a boss disposed on the holder is inserted into a hole formed in the substrate, so that the substrate is positioned with respect to the holder. In the image forming apparatus discussed in Japanese Patent Application Publication No. 2023-78633, a screw is inserted into a hole that passes through the holder and a hole that passes through the substrate, so that the holder and the substrate are fixed to a frame of the developing unit, by the screw. Thus, it is necessary to secure a space in the substrate for forming the hole for the screw, in addition to the hole for positioning the substrate with respect to the holder. As a result, the apparatus increases in size.

### SUMMARY

An aspect of the present disclosure provides a substrate unit includes a sensor configured to output a signal that corresponds to an amount of toner stored in a storage portion configured to store the toner, a substrate including the sensor and a hole, a holder including a boss configured to be inserted into the hole, the holder being configured to hold the substrate, and a push nut configured to position the substrate with respect to the holder. The push nut engages with the boss such that the substrate is disposed between the holder and the push nut.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of an image forming apparatus of a first embodiment.

FIG. 2 is a block diagram illustrating a control system of the image forming apparatus of the first embodiment.

FIG. 3A is a perspective view illustrating a configuration in which a printed substrate is attached to a holder of a toner-remaining-amount detection sensor unit of the first embodiment.

FIG. 3B is a perspective view illustrating a state where the printed substrate is attached to the holder of the toner-remaining-amount detection sensor unit.

FIG. 3C is an enlarged view in which a boss of the holder inserted in a hole of the printed substrate in the toner-remaining-amount detection sensor unit is viewed from above.

FIG. 4 is a schematic cross-sectional view of the toner-remaining-amount detection sensor unit of the first embodiment.

FIG. 5 is a cross-sectional view of the printed substrate of the first embodiment, and a plan view of a surface of the printed substrate on which a light emitting element and a light receiving element are disposed.

FIG. 6 is a plan view of the printed substrate of the first embodiment, viewed from the side of the surface of the printed substrate on which the light emitting element and the light receiving element are disposed.

FIG. 7A is a perspective view illustrating a configuration in which a printed substrate is attached to a holder of a toner-remaining-amount detection sensor unit of a second embodiment.

FIG. 7B is a perspective view illustrating a state where the printed substrate is attached to the holder of the toner-remaining-amount detection sensor unit.

FIG. 7C is an enlarged view in which a boss of the holder inserted in a hole of the printed substrate in the toner-remaining-amount detection sensor unit is viewed from above.

FIG. 8 is a plan view of the printed substrate of the second embodiment, viewed from the side of a surface of the printed substrate on which a light emitting element and a light receiving element are disposed.

### DESCRIPTION OF THE EMBODIMENTS

### First Embodiment

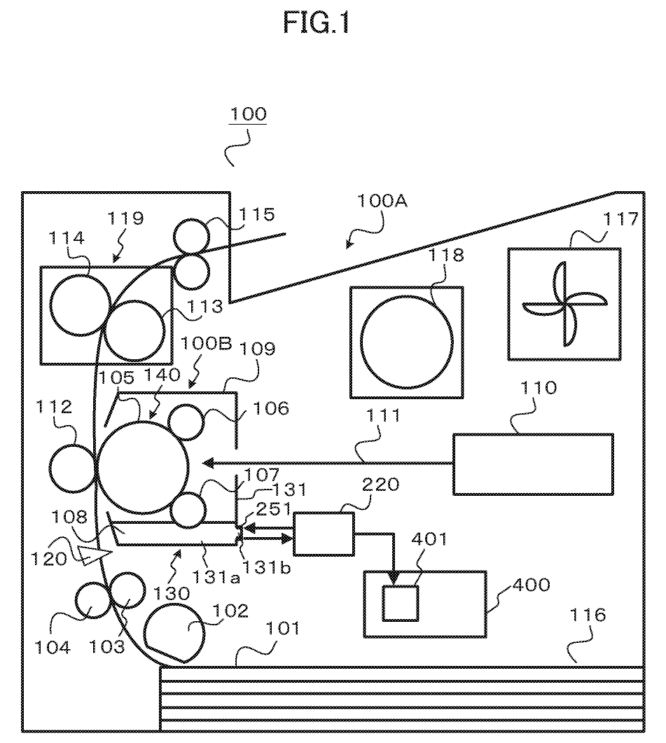

Hereinafter, a first embodiment of the present disclosure will be described in detail with reference to the accompanying drawings. FIG. 1 is a cross-sectional view illustrating a schematic configuration of an image forming apparatus 100 of the first embodiment.

### Image Forming Apparatus

As illustrated in FIG. 1, the image forming apparatus 100 of the first embodiment includes a printer body 100A as an apparatus body, an image forming portion 100B, and a fixing unit 119. The printer body 100A includes a feeding cassette 116 that stores a recording material 101, a feeding roller 102 that picks up and feeds the recording material 101 from the feeding cassette 116, and conveyance rollers 103 and 104 that convey the recording material 101. The printer body 100A includes a discharging roller 115 that discharges the recording material 101.

In the image forming apparatus 100, when an image forming operation is started, the recording material 101 is picked up from the feeding cassette 116 by the feeding roller 102 and conveyed by the conveyance rollers 103 and 104. When the conveyance of the recording material 101 is started, the image forming apparatus 100 detects the leading edge and the trailing edge of the recording material 101 by using a sheet detection flag 120. By detecting the leading edge of the recording material 101, the image forming apparatus 100 determines the timing for starting each electrophotographic process.

The image forming portion 100B includes a process cartridge 109 that serves as a developing apparatus, a transfer roller 112, and a scanning optical apparatus 110. The process cartridge 109 includes a drum unit 140 that includes a photosensitive drum 105 serving as an image bearing member, and a charging roller 106 serving as a charging unit. The process cartridge 109 also includes a developing unit 130 that serves as a developing unit.

The developing unit 130 includes a developing roller 107 serving as a developer bearing member that bears developer, and a developer container 131 serving as a frame of the developing unit 130. The developer container 131 serves as a storage portion stores a toner 108 in a developer storage chamber 131a, which is a space inside the developer container 131. The developer container 131 includes an agitating member that agitates the toner stored in the developer storage chamber 131a.

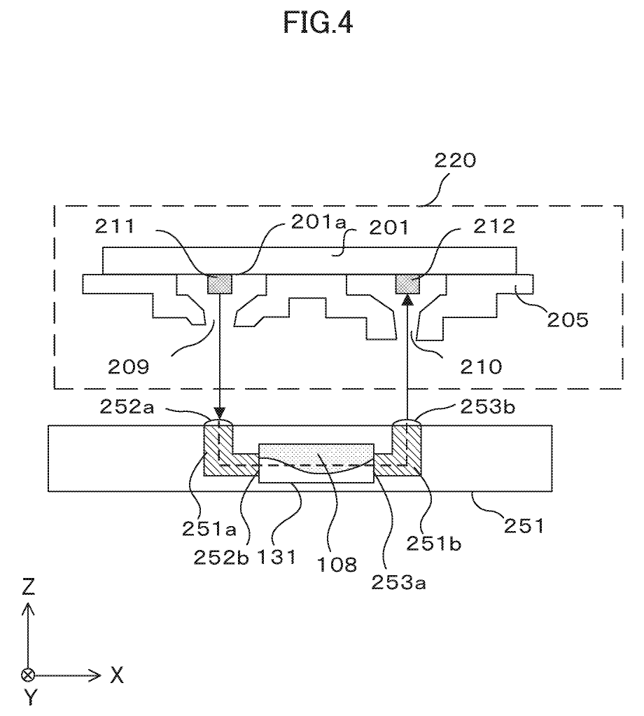

The developer container 131 is provided with a remaining-amount detection opening 131b, and a light guide 251 is attached to the developer container 131 so as to cover the remaining-amount detection opening 131b. That is, a part of the light guide 251 is accommodated in the developer storage chamber 131a, which is an internal space of the developer container 131, via the remaining-amount detection opening 131b. The light guide 251 guides an optical path from a light emitting element 211 (see FIG. 4) to a light receiving element 212 (see FIG. 4) disposed in a toner-remaining-amount detection sensor unit 220.

The remaining amount of the toner 108 stored in the developer storage chamber 131a is detected by the toner-remaining-amount detection sensor unit 220 disposed so as to face the light guide 251. The toner-remaining-amount detection sensor unit 220 is attached to the developing unit 130. The toner-remaining-amount detection sensor unit 220 transmits, to a central processing unit (CPU) 401 of a control portion 400 that serves as an engine control unit, a signal (output value) corresponding to a result detected by the light emitting element 211 and the light receiving element 212 that serve as a sensor. In a case where the remaining amount of toner becomes low, a user is notified by an image displayed on a display unit disposed in the printer body 100A or by sound. The toner-remaining-amount detection sensor unit 220 is described below.

In the image forming apparatus 100, when an operation for forming an image on the recording material 101 (image forming operation) is started, a high voltage is applied to the charging roller 106. The surface of the photosensitive drum 105 is charged substantially uniformly by the charging roller 106. The scanning optical apparatus 110 that serves as an exposure unit scans the surface of the photosensitive drum 105 with a laser beam 111 in accordance with image information, thereby forming an electrostatic latent image in an image forming area. A high voltage is applied to the developing roller 107, and charged toner is supplied to the photosensitive drum 105, so that the electrostatic latent image is developed into a toner image. The toner image formed is transferred from the photosensitive drum 105 to the recording material 101 by a high voltage applied to the transfer roller 112.

The recording material 101 onto which the toner image has been transferred is heated and pressed by the fixing unit 119, which includes a heating apparatus 113 and a pressing roller 114 and is driven and controlled by the CPU 401 of the control portion 400, so that the toner 108 is fixed to the recording material 101. By fixing the toner 108 to the recording material 101, an image is formed on the recording material 101. The recording material 101 on which the image has been formed is discharged by the discharging roller 115. Thus, the image formation on the recording material 101 by the image forming apparatus 100 is completed.

In a case where images are continuously formed, the image forming apparatus 100 can determine the timing for starting conveyance of a next recording material by causing the sheet detection flag 120 to detect the trailing edge of the recording material 101. The image forming apparatus 100 also includes a fan 117. The fan 117 is disposed to prevent the toner 108 of the process cartridge 109 from solidifying and becoming fixed due to the heat generated by the heating apparatus 113 and to suppress the heat generated by electrical components that include a power supply apparatus. A motor 118 applies driving force to units that include the pressing roller 114. Two or more motors may be used as a driving source for applying driving force to each unit.

### Control System of Image Forming Apparatus

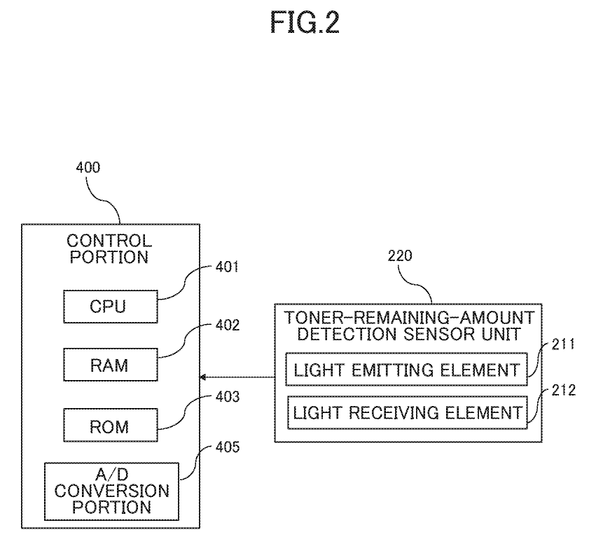

FIG. 2 is a block diagram illustrating a control system of the image forming apparatus 100. The control portion 400 of the image forming apparatus 100 includes the CPU 401 that serves as a computing apparatus, a random access memory (RAM) 402 used as a work area of the CPU 401, and a read only memory (ROM) 403 that stores various programs. The control portion 400 includes an analog/ digital (A/D) conversion portion 405 that converts analog signals into digital signals.

On the input side of the control portion 400, the toner-remaining-amount detection sensor unit 220 that serves as a substrate unit is connected to the control portion 400. The CPU 401 of the control portion 400 determines whether the light receiving element 212 has received light from the light emitting element 211, based on the level of a voltage received by the toner-remaining-amount detection sensor unit 220.

A power supply voltage and a current limiting resistor are connected to the light emitting element 211, and the light emitting element 211 emits light based on a current determined by the current limiting resistor. The light emitted from the light emitting element 211 passes through an optical path, as described herein, and is received by the light receiving element 212. A power supply voltage is connected to a collector terminal of the light receiving element 212, and a detection resistor is connected to an emitter terminal of the light receiving element 212. The light receiving element 212, which is a phototransistor, receives the light emitted from the light emitting element 211 and outputs a signal (e.g., a current, output value) corresponding to a length of time in which the light is detected by the light receiving element 212 and the amount of light received by the light receiving element 212. The signal is converted into a voltage by the detection resistor and sent to the A/D conversion portion 405 of the control portion 400. That is, the light receiving element 212 changes its output value in accordance with the amount of toner (developer) stored in the developer container 131. In other words, the light receiving element 212 outputs a signal corresponding to the amount of toner stored in the developer container 131.

The CPU 401 calculates the amount of the toner 108 stored in the developer container 131, based on the length of time in which the light receiving element 212 detects the light and on the amount of light detected by the light receiving element 212 in a case where the toner 108 stored in the developer container 131 is agitated for a predetermined time by an agitating member.

### Attaching Substrate in Toner-Remaining-Amount Detection Sensor Unit

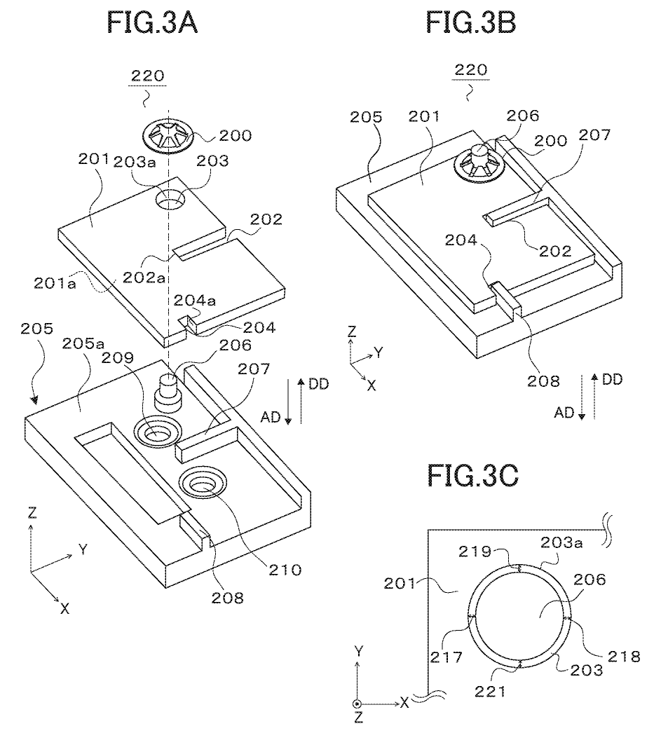

A toner-remaining-amount detection sensor unit 220 of the first embodiment is described with reference to FIGS. 3A to 3C. The XYZ coordinate system in FIGS. 3A to 3C indicates directions in a case where a printed substrate 201 is attached to a holder 205 in the toner-remaining-amount detection sensor unit 220. The X direction and the Y direction are parallel with a surface of the printed substrate 201, and are orthogonal to each other. The Z direction indicates a height direction orthogonal to the X direction and the Y direction. A direction of the Z direction in which the printed substrate 201 is attached to the holder 205 serves as an attachment direction AD. As illustrated, the attachment direction AD is a -Z direction. The +Z direction which is opposite to the attachment direction AD and in which the printed substrate 201 is separated from the holder 205 serves as a detachment direction DD. As illustrated, the detachment direction DD is a +Z direction.

FIG. 3A is a perspective view illustrating a configuration in which the printed substrate 201, which serves as a substrate, is attached to the holder 205 of the toner-remaining-amount detection sensor unit 220. FIG. 3B is a perspective view illustrating a state where the printed substrate 201 is attached to the holder 205 of the toner-remaining-amount detection sensor unit 220. In the printed substrate 201, as further described below, the light emitting element 211 (see FIG. 4) and the light receiving element 212 (see FIG. 4) are disposed on a surface 201a that faces the holder 205. Electronic circuit components are disposed on the printed substrate 201.

As illustrated in FIG. 3A, the toner-remaining-amount detection sensor unit 220 includes the holder 205, the printed substrate 201, the light emitting element 211 and the light receiving element 212 disposed on the printed substrate 201, and a push nut 200, as described below. In the printed substrate 201, a hole perimeter 203a that forms a first through-hole portion and a second engaging portion is disposed. The hole perimeter 203a, i.e., hole 203 that serves as a first hole and a first through hole, and is used for positioning the printed substrate 201 with respect to the holder 205 in the X direction and the Y direction. In the printed substrate 201, a slit 202 and a recess portion 204 are disposed. The slit 202 is disposed at a position between the light emitting element 211 and the light receiving element 212 of the printed substrate 201. A rib 207 formed on the holder 205 is inserted into the slit 202, and the slit 202 serves as a groove portion and an engaged portion that engage with the rib 207. On the other hand, a rib 208 formed on the holder 205 is inserted into the recess portion 204, and the recess portion 204 serves as an engaged portion and a fourth engaging portion that engage with the rib 208.

The holder 205 is attached to the developer container 131 (see FIG. 1), and holds the printed substrate 201. On the holder 205, a boss 206 that serves as a first projection portion and a first engaging portion is disposed. The boss 206 is inserted into the hole 203 of the printed substrate 201, and is used for positioning the printed substrate 201 with respect to the holder 205 in the X direction and the Y direction. On the holder 205, the rib 207 is disposed. The rib 207 is inserted into the slit 202 of the printed substrate 201, and serves as a projection portion and an engaging portion that engage with the slit 202. On the holder 205, the rib 208 that serves as a third engaging portion and an engaging portion is disposed. The rib 208 is inserted into the recess portion 204 of the printed substrate 201, and engages with the recess portion 204. Since the rib 207 engages with the slit 202 and the rib 208 engages with the recess portion 204, the printed substrate 201 is restricted from rotating around a rotation axis that extends along a direction (i.e., the Z direction) in which the boss 206 extends.

The holder 205 includes a surface 205a that serves as a facing surface that faces the surface 201a of the printed substrate 201. The boss 206, the rib 207, and the rib 208 project from the surface 205a toward the detachment direction DD. In the holder 205, an opening portion 209 and an opening portion 210 are disposed. The light emitted from the light emitting element 211 passes through the opening portion 209, and the opening portion 210 is disposed for the light receiving element 212 to receive the light. In addition, in the holder 205, the boss 206, the rib 207, and the rib 208 are molded integrally with each other.

Thus, in the toner-remaining-amount detection sensor unit 220, the number of components, which are the boss 206, the rib 207, and the rib 208, is reduced, and the manufacturing cost of the holder 205 is reduced.

As illustrated in FIG. 3B, in the toner-remaining-amount detection sensor unit 220, the printed substrate 201 is moved closer to and attached to the holder 205 in a state where the surface 205a of the holder 205 and the surface 201a of the printed substrate 201 face each other. That is, the printed substrate 201 is attached to the holder 205 in the attachment direction AD.

The printed substrate 201 is restricted from moving in the X direction and the Y direction in FIG. 3A, by the boss 206 inserted in the hole 203. In other words, since the hole perimeter 203a that forms the hole 203 engages with the boss 206, the printed substrate 201 is positioned with respect to the holder 205 in directions orthogonal to the attachment direction AD, that is, in directions parallel to an XY plane.

The printed substrate 201 is restricted by the rib 208, inserted in the recess portion 204, from moving in a direction in which the printed substrate 201 would rotate around the boss 206 in an XY plane. In other words, since the recess portion 204 engages with the rib 208, the printed substrate 201 is restricted from rotating around the boss 206 in a direction orthogonal to the attachment direction AD.

In such a configuration, the printed substrate 201 of the first embodiment is positioned with respect to the holder 205 in an XY plane, by the boss 206 and the rib 208. That is, the light emitting element 211 and the light receiving element 212 disposed on the printed substrate 201 can be restricted from being shifted in position with respect to the developer container 131 and the holder 205 in the X direction and the Y direction.

Thus, the light emitted from the light emitting element 211 of the printed substrate 201 can reach the light receiving element 212 along an intended optical path. As a result, the detection accuracy of the remaining amount of the toner 108 stored in the developer container 131 can be increased.

After the printed substrate 201 is attached to the holder 205, the push nut 200 that serves as a fixing member and a first fixing member is assembled to the boss 206. The push nut 200 fixes the printed substrate 201 to the holder 205 by restricting the printed substrate 201 from moving with respect to the holder 205 in the detachment direction DD opposite to the attachment direction AD. In other words, the push nut 200 engages with the boss 206 such that the printed substrate 201 is disposed between the holder 205 and the push nut 200, and thereby positions the printed substrate 201 with respect to the holder 205.

In this manner, in the toner-remaining-amount detection sensor unit 220, the boss 206 used for positioning the printed substrate 201 with respect to the holder 205 in the X direction and the Y direction is provided with the push nut 200, and thereby the printed substrate 201 is fixed to the holder 205 (that is, restricted from being separated from the holder 205).

Thus, in the toner-remaining-amount detection sensor unit 220, the printed substrate 201 can be fixed to the holder 205 without using the hole and the screw for fixing the printed substrate 201 to the holder 205, so that the printed substrate 201 can be downsized.

In general, as the distance between the light emitting element and the light receiving element decreases in the printed substrate, unintended light (hereinafter referred to also as stray light) from the light emitting element is more easily incident on the light receiving element, possibly deteriorating the detection accuracy of the sensor.

In the toner-remaining-amount detection sensor unit 220 of the first embodiment, however, since the slit 202 is disposed in the printed substrate 201, and the rib 207 that fits in the slit 202 is disposed on the holder 205, the stray light is restricted from directly reaching the light receiving element 212 from the light emitting element 211.

FIG. 3C is an enlarged view in which the boss 206 of the holder 205 inserted in the hole 203 of the printed substrate 201 in the toner-remaining-amount detection sensor unit 220, as viewed from above. As illustrated in FIG. 3C, in a case where the position of the center of the hole 203 in the X direction and the Y direction and the position of the center of the boss 206 in the X direction and the Y direction are made equal to each other, clearances 217 and 218 in the X direction and clearances 219 and 221 in the Y direction are formed between the inner circumference of the hole 203 and the outer circumference of the boss 206. The hole 203 of the printed substrate 201 and the boss 206 of the holder 205 are formed such that each of the clearances 217, 218, 219, and 221 is equal to or smaller than 0.5 mm. That is, the clearance formed between the inner circumference of the hole 203 and the outer circumference of the boss 206 is equal to or smaller than 1 mm.

With such a configuration, in the toner-remaining-amount detection sensor unit 220, the printed substrate 201 is restricted from moving with respect to the holder 205 in the X direction and the Y direction, so that the printed substrate 201 can be attached to the holder 205 with high accuracy.

As a result, in the toner-remaining-amount detection sensor unit 220, the light from the light emitting element 211 of the printed substrate 201 can travel along an intended optical path and reach the light receiving element 212, so that the detection accuracy of the remaining amount of the toner 108 stored in the developer container 131 can be increased.

In the toner-remaining-amount detection sensor unit 220, undesired stray light that deviates from the optical path can be restricted and reduced, so that the deterioration of the detection accuracy of the remaining amount of the toner, caused by the stray light received by the light receiving element 212, can be restricted.

### Toner-Remaining-Amount Detection Sensor Unit

FIG. 4 is a schematic cross-sectional view of the toner-remaining-amount detection sensor unit 220. As illustrated in FIG. 4, in the toner-remaining-amount detection sensor unit 220, the light emitting element 211 and the light receiving element 212 are disposed on the same surface 201a such that each of the center optical axis of the light emitting element 211 and the center optical axis of the light receiving element 212 is substantially orthogonal to the surface 201a, which is a surface of the printed substrate 201.

The light emitting element 211 that emits light toward the interior of the developer container 131 of the developing unit 130 (see FIG. 1) may be an LED infrared-ray emitting element. The light receiving element 212 outputs a signal (i.e., an output value) that corresponds to the amount of the toner 108 stored in the developer container 131, depending on the amount of light emitted from the light emitting element 211, having passed through the interior of the developer container 131, and received by the light receiving element 212. The light receiving element 212 may be a phototransistor infrared-rays receiving element. Each of the light emitting element 211 and the light receiving element 212 is a bare-chip element.

As described above, in the process cartridge 109, the light guide 251 is disposed so as to cover the remaining-amount detection opening 131b disposed in the developer container 131 of the developing unit 130. The light guide 251 is disposed so as to face the printed substrate 201; and guides the light outputted from the light emitting element 211, to the light receiving element 212.

The light guide 251 includes an incident end 252a on which the light emitted from the light emitting element 211 is incident, an internal emission end 252b from which the light incident on the incident end 252a is emitted, and an input-side guide 251a which forms an optical path from the incident end 252a to the internal emission end 252b. The light guide 251 includes an internal incident end 253a on which the light emitted from the internal emission end 252b is incident, and an emission end 253b from which the light incident on the internal incident end 253a is emitted. The light guide 251 includes an output-side guide 251b that forms an optical path from the internal incident end 253a to the emission end 253b.

The incident end 252a and the emission end 253b are disposed outside the developer container 131. The internal emission end 252b and the internal incident end 253a are disposed so as to face each other in the developer container 131, and form a spatial optical path that passes across a portion of the developer storage chamber 131a.

The light emitted from the light emitting element 211 passes through the opening portion 209 of the holder 205, and is emitted to the incident end 252a of the light guide 251. The light incident on the incident end 252a is guided to the developer storage chamber 131a by the input-side guide 251a, and is emitted from the internal emission end 252b. The light emitted from the internal emission end 252b passes through the spatial optical path that passes across a portion of the developer storage chamber 131a, and is incident on the internal incident end 253a. The light incident on the internal incident end 253a is guided to the emission end 253b by the output-side guide 251b, and is emitted from the emission end 253b. The light emitted from the emission end 253b passes through the opening portion 210, and is incident on the light receiving element 212. Then, based on the amount of light received by the light receiving element 212, the light receiving element 212 outputs a signal (i.e., an output value) that corresponds to the amount of the toner 108 stored in the developer storage chamber 131a.

In a case where the light that travels in the light guide 251 passes through the spatial optical path that passes across a portion of the developer storage chamber 131a, the light is attenuated when passing through the toner 108 that is stored in the developer storage chamber 131a. In a case where the light that travels in the light guide 251 passes through the spatial optical path that passes across a portion of the developer storage chamber 131a, without passing through the toner 108 stored in the developer storage chamber 131a, the light passes though the spatial optical path without being attenuated.

In the toner-remaining-amount detection sensor unit 220, if the positions of the light emitting element 211 and the light receiving element 212 disposed on the printed substrate 201 are shifted from the incident end 252a and the emission end 253b of the light guide 251, the amount of light that passes through the light guide 251 decreases. In the toner-remaining-amount detection sensor unit 220, if the positions of the light emitting element 211 and the light receiving element 212 disposed on the printed substrate 201 are shifted from the incident end 252a and the emission end 253b of the light guide 251, the stray light that deviates from the optical path increases.

### Stray Light possibly incident on Light Receiving Element

In the printed substrate 201, if the distance between the light emitting element 211 and the light receiving element 212 is shortened for downsizing, the stray light emitted from the light emitting element 211 may be incident on the light receiving element 212 via the printed substrate 201. If the stray light is incident on the light receiving element 212, the detection accuracy of the remaining amount of the toner 108 by the toner-remaining-amount detection sensor unit 220 may deteriorate.

Some of the stray light that possibly is incident on the light receiving element 212 enters the interior of the printed substrate 201 from an area of a surface of the printed substrate 201 on which no copper pattern is formed. The light that enters the interior of the printed substrate 201 passes through the interior of the printed substrate 201, then is discharged to the outside of the printed substrate 201 from an area on which no copper pattern is formed, and then may reach the light receiving element 212.

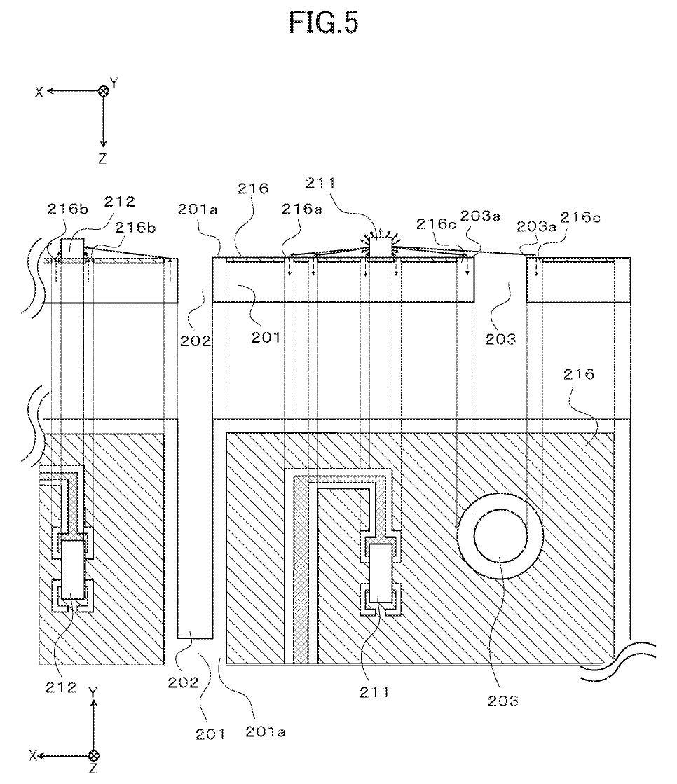

The stray light that is discharged from the interior of the printed substrate 201 to the outside of the printed substrate 201 and that reaches the light receiving element 212 is described with reference to FIG. 5. FIG. 5 is a cross-sectional view of the printed substrate 201 and a plan view of the surface 201a.

As illustrated in FIG. 5, a copper pattern 216 having high light blocking effect is formed on the surface 201a. The surface 201a of the printed substrate 201 includes an area on which the copper pattern 216 is formed, and a clearance 216a on which the copper pattern 216 is not formed. As indicated by solid line arrows in FIG. 5, the light emitting element 211 emits light in substantially every direction. Thus, as indicated by dotted line arrows in FIG. 5, some of the light emitted from the light emitting element 211 becomes stray light and enters the interior of the printed substrate 201 from the clearance 216a.

The stray light that has entered the interior of the printed substrate 201 travels through a portion connected to the printed substrate 201, and passes through to the vicinity of the light receiving element 212. The stray light is then discharged to the outside of the printed substrate 201 from a clearance 216b on which the copper pattern 216 is not formed in the vicinity of the light receiving element 212, and is received by the light receiving element 212.

For restricting the stray light that enters the interior of the printed substrate from the clearance on which no copper pattern is formed, from being received by the light receiving element, a copper solid pattern may be formed on the printed substrate for reducing the clearance as much as possible.

However, in the printed substrate 201, it is not possible to form a copper pattern on the hole perimeter 203a that forms the hole 203 formed for the positioning, in the manufacturing process of the printed substrate. Thus, it is not possible to eliminate the clearance 216c, and part of the light emitted from the light emitting element 211 becomes stray light that enters the interior of the printed substrate 201 from the clearance 216c.

### Structure of Printed Substrate

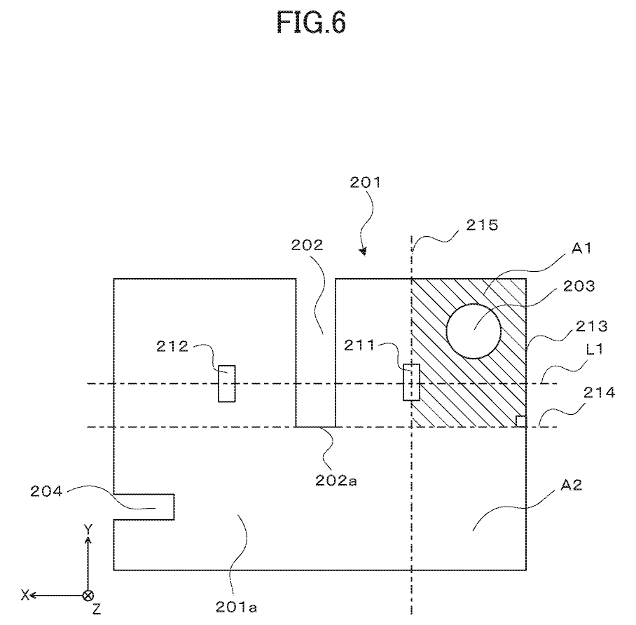

FIG. 6 is a plan view of the printed substrate 201 of the first embodiment, viewed from the side of the surface 201a of the printed substrate 201 on which the light emitting element 211 and the light receiving element 212 are disposed.

In FIG. 6, a first substrate edge 213 of the printed substrate 201 is positioned, when viewed in the X direction from the light emitting element 211, on a side opposite to a side on which the light receiving element 212 is disposed, extending in parallel with the Y direction. In other words, the first substrate edge 213 is an edge portion of the printed substrate 201 that extends in the Y direction orthogonal to the Z direction.

A line L1 is an imaginary line that connects the light emitting element 211 and the light receiving element 212, and extends in the X direction. A line 214 is an auxiliary line that passes through a closed end 202a of the slit 202, and that is orthogonal to the first substrate edge 213. In the printed substrate 201 of the first embodiment, the closed end 202a of the slit 202 is positioned at the center of the printed substrate 201 in the Y direction. A line 215 is an auxiliary line that passes through the center of the light emitting element 211 obtained in the X direction, and that is parallel with the first substrate edge 213.

In other words, when viewed in the Z direction, the line 214 is a straight line that extends in the X direction, and that passes through the center of the printed substrate 201 in the Y direction. The X direction is a direction in which the light emitting element 211 and the light receiving element 212 are disposed side by side, which is orthogonal to the Z direction, and in which the line L1 extends. When viewed in the Z direction, the line 215 is a straight line that extends in the Y direction orthogonal to the X direction, and that passes through the light emitting element 211. The X direction serves as a first direction, and the Y direction serves as a second direction. The second direction is orthogonal to both of the X direction and the Z direction. The Z direction is a normal direction perpendicular to the surface 201a of the printed substrate 201. The line 214 serves as a first straight line, and the line 215 serves as a second straight line.

In the printed substrate 201, the light emitting element 211, the light receiving element 212, and the hole 203 are disposed on one side of the line 214 in the Y direction. In the printed substrate 201, the hole 203 is disposed in an area A1 which is surrounded by the first substrate edge 213, the line 214, and the line 215, and in which a portion of the light emitting element 211 is included. In the printed substrate 201, when viewed in the Z direction, the hole 203 is disposed at a position closer to the light emitting element 211 than to the light receiving element 212. In other words, when viewed in the Z direction in which the boss 206 extends, the shortest distance between the hole 203 and the light emitting element 211 is shorter than the shortest distance between the hole 203 and the light receiving element 212.

Thus, in the printed substrate 201, since the hole 203 is disposed opposite to the light receiving element 212 with respect to the line 215 in the X direction, the distance between the light receiving element 212 and the hole 203 is increased, so that the influence caused by the stray light that enters the interior of the printed substrate 201 from the clearance 216c is reduced.

With this configuration, in the toner-remaining-amount detection sensor unit 220 of the first embodiment, since the stray light that has entered the printed substrate 201 from the hole 203 is attenuated by the time the stray light passes through to the vicinity of the light receiving element 212, the stray light that reaches the light receiving element 212 is reduced.

In the printed substrate 201, a positioning hole may be provided in an area A2 which is surrounded by the first substrate edge 213 illustrated in FIG. 6, the line 214, and the line 215, and in which the light emitting element 211 is not included. In this case, however, in the printed substrate 201, a portion of the printed substrate 201 whose position is fixed by the push nut 200 (see FIG. 3) in the Z direction is further separated from the light emitting element 211 than in a case where the positioning hole is disposed in the area A1.

In the printed substrate 201, if the distance between the portion of the printed substrate 201 whose position is fixed in the Z direction and the light emitting element 211 is increased, the center optical axis of the light emitting element 211 is easily shifted from the opening portion 209 of the holder 205 in a case where the printed substrate 201 is separated from the holder 205, so as to float away from the holder 205, due to the warpage or the like of the printed substrate 201 in the Z direction. In this case, in the toner-remaining-amount detection sensor unit 220, it becomes difficult for the light emitted from the light emitting element 211 to enter the light guide 251 (see FIG. 4), so that the amount of light used for detecting the remaining amount of the toner 108 decreases. In the toner-remaining-amount detection sensor unit 220, the light that fails to enter the light guide 251 may become new stray light.

In contrast, in the printed substrate 201 of the first embodiment, the hole 203 is disposed in the area A1 that is in the vicinity of the light emitting element 211, and the positioning in the Z direction is performed by using the push nut 200 provided to the boss 206 of the holder 205 that engages with the hole perimeter 203a of the hole 203.

Thus, the toner-remaining-amount detection sensor unit 220 of the first embodiment can restrict the light emitting element 211 from being separated from the holder 205 so as to float away from the holder 205, and can restrict the reduction of the amount of light used for detecting the remaining amount of the toner 108. The toner-remaining-amount detection sensor unit 220 can restrict the increase of the light that is emitted from the light emitting element 211 and that fails to enter the light guide 251 and becomes the stray light.

In the printed substrate 201, when viewed in the Z direction, the recess portion 204 is disposed closer to the light receiving element 212 than to the light emitting element 211.

In such a configuration, in the toner-remaining-amount detection sensor unit 220 of the first embodiment, the stray light from the light emitting element 211 can be attenuated by the time when the stray light reaches an edge portion of the recess portion 204 on which no copper pattern is formed. Thus, in the toner-remaining-amount detection sensor unit 220, the amount of stray light that enters the printed substrate 201 from the edge portion of the recess portion 204 and that is received by the light receiving element 212 is reduced. As a result, the deterioration of the detection accuracy of the toner-remaining-amount detection sensor unit 220 is reduced.

In the printed substrate 201, when viewed in the Z direction, the shortest distance between the light emitting element 211 and the recess portion 204 is longer than the shortest distance between the light emitting element 211 and the light receiving element 212.

In such a configuration, in the toner-remaining-amount detection sensor unit 220, the distance in which the stray light from the light emitting element 211 travels until the stray light reaches an edge portion of the recess portion 204 on which no copper pattern is formed is longer than the distance between the light emitting element 211 and the light receiving element 212. Thus, in the toner-remaining-amount detection sensor unit 220, the stray light that enters the printed substrate 201 from the edge portion of the recess portion 204 is attenuated and the amount of stray light received by the light receiving element 212 is reduced. As a result, the deterioration of the detection accuracy of the toner-remaining-amount detection sensor unit 220 is reduced.

### Summary of First Embodiment

As described above, in the toner-remaining-amount detection sensor unit 220 of the first embodiment, the boss 206 used for positioning the printed substrate 201 with respect to the holder 205 in the X direction and the Y direction orthogonal to the Z direction is provided with the push nut 200. The push nut 200 engages with the boss 206 such that the printed substrate 201 is disposed between the holder 205 and the push nut 200, and thereby positions the printed substrate 201 with respect to the holder 205.

Thus, in the toner-remaining-amount detection sensor unit 220, the printed substrate 201 can be fixed to the holder 205 without using the hole and the screw used for fixing the printed substrate 201 to the holder 205, so that the printed substrate 201 can be downsized.

In the toner-remaining-amount detection sensor unit 220, the hole 203 in which no copper pattern can be formed on the hole perimeter 203a in the printed substrate 201, and the boss 206 of the holder 205 are disposed in the area A1 that is in the vicinity of the light emitting element 211 and that is separated from the light receiving element 212.

Thus, in the toner-remaining-amount detection sensor unit 220, the stray light that has entered the printed substrate 201 from the hole perimeter 203a of the hole 203 is attenuated by the time when the stray light passes through to the vicinity of the light receiving element 212, and deterioration of the detection accuracy of the remaining amount of the toner 108, caused by the stray light that reaches the light receiving element 212, is reduced.

The toner-remaining-amount detection sensor unit 220 can restrict the light emitting element 211 from being shifted in position in a direction in which the light emitting element 211 is separated from the holder 205, and can restrict the reduction of the amount of light used for detecting the remaining amount of the toner 108. The toner-remaining-amount detection sensor unit 220 can restrict the increase of the stray light that is emitted from the light emitting element 211 and that fails to enter the light guide 251.

Thus, the toner-remaining-amount detection sensor unit 220 can restrict both of the reduction of the amount of light used for detecting the remaining amount of the toner 108 and the occurrence of stray light, and can restrict the deterioration of the detection accuracy of the remaining amount of the toner 108.

### Second Embodiment

A toner-remaining-amount detection sensor unit of a second embodiment will be described. In the toner-remaining-amount detection sensor unit of the second embodiment, the printed substrate includes a plurality of positioning holes, a plurality of bosses disposed on the holder is inserted into the respective holes, and the plurality of bosses is fixed by a plurality of push nuts. In this point, the toner-remaining-amount detection sensor unit of the second embodiment differs from that of the above-described first embodiment. Since the other configuration of the second embodiment is the same as that of the first embodiment, a component identical to that of the first embodiment is given an identical symbol. For conciseness, the description thereof is incorporated by reference without being repeated.

### Attaching Substrate in Toner-Remaining-Amount Detection Sensor Unit

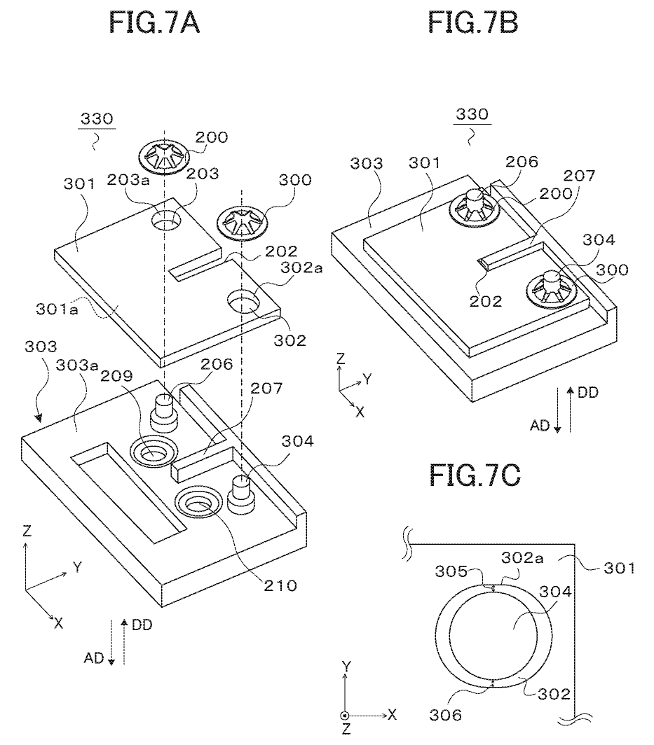

A toner-remaining-amount detection sensor unit 330 of the second embodiment is described with reference to FIGS. 7A to 7C. The XYZ coordinate system in FIGS. 7A to 7C is illustrated for indicating directions in a case where a printed substrate 301 is attached to a holder 303 in the toner-remaining-amount detection sensor unit 330. The X direction and the Y direction indicate directions parallel with a surface of the printed substrate 301, and are orthogonal to each other. The Z direction represents a height direction orthogonal to the X direction and the Y direction.

FIG. 7A is a perspective view illustrating a configuration in which the printed substrate 301, which serves as a substrate, is attached to the holder 303 of the toner-remaining-amount detection sensor unit 330. FIG. 7B is a perspective view illustrating a state where the printed substrate 301 is attached to the holder 303 of the toner-remaining-amount detection sensor unit 330.

As illustrated in FIG. 7A, the toner-remaining-amount detection sensor unit 330 of the second embodiment includes the holder 303, the printed substrate 301, and the light emitting element 211 and the light receiving element 212 disposed on the printed substrate 301. The toner-remaining-amount detection sensor unit 330 includes below-described push nuts 200 and 300. The printed substrate 301 is attached to the holder 303 in the attachment direction AD. The printed substrate 301 includes holes 203 and 302 used for positioning the printed substrate 301 with respect to the holder 303 in the X direction and the Y direction. The hole 302 that serves as a second hole and a second through hole is constituted by a hole portion 302a that serves as a second through-hole portion and a fourth engaging portion.

The holder 303 includes a surface 303a that serves as a facing surface that faces a surface 301a of the printed substrate 301. Bosses 206 and 304 and the rib 207 project from the surface 303a in the detachment direction DD. In the holder 303, the bosses 206 and 304 are molded integrally with each other.

Thus, in the toner-remaining-amount detection sensor unit 330, the number of components, e.g. the bosses 206 and 304, is reduced, and the manufacturing cost of the holder 303 is reduced.

As in the first embodiment, since the hole perimeter 203a engages with the boss 206, the printed substrate 301 is positioned with respect to the holder 205 in directions orthogonal to the attachment direction AD, that is, in directions parallel to an XY plane. The boss 304 that serves as a second boss, a third engaging portion, and a second projection portion is inserted into the hole 302 of the printed substrate 301 and engages with the hole 302. In this manner, the boss 304 restricts the printed substrate 301 from rotating around the boss 206 as a rotation axis.

As illustrated in FIG. 7B, in the toner-remaining-amount detection sensor unit 330, the printed substrate 301 is attached to the holder 303. In the toner-remaining-amount detection sensor unit 330, the push nut 200 is inserted into the boss 206 and the push nut 300 is inserted into the boss 304, so that the printed substrate 301 is fixed to the holder 303.

By inserting the boss 206 in the hole 203 and the boss 304 in the hole 302, printed substrate 301 is restricted from moving in the X direction and the Y direction as shown in FIG. 7A, and from moving in a direction in which the printed substrate 301 would rotate in an XY plane. That is, the position of the printed substrate 301 with respect to the holder 303 in an XY plane is maintained by the bosses 206 and 304. In other words, since the hole portion 302a of the hole 302 engages with the boss 304, the printed substrate 301 is restricted from rotating around the boss 206 in an XY plane.

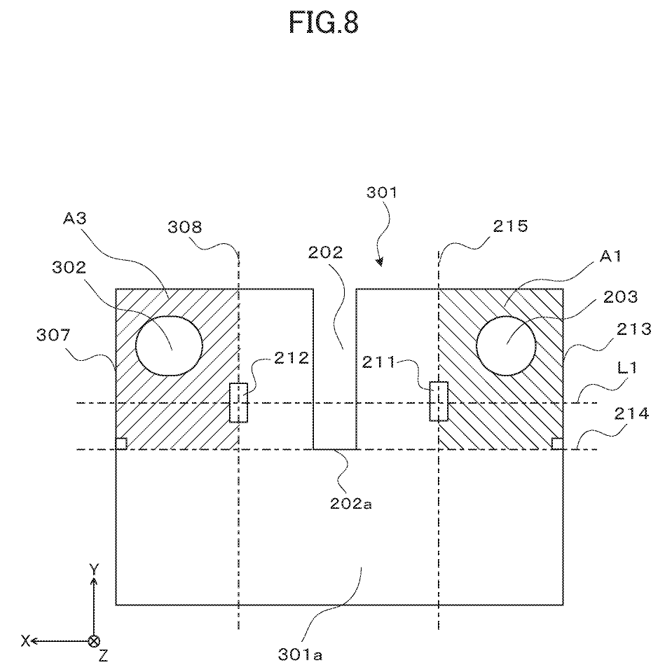

In such a configuration, the printed substrate 301 of the second embodiment is positioned with respect to the holder 303 in directions orthogonal to the attachment direction AD, that is, in directions parallel to an XY plane, by the bosses 206 and 304. The light emitting element 211 (see FIG. 8) and the light receiving element 212 (see FIG. 8) disposed on the printed substrate 301 can be restricted from being shifted in position with respect to the developer container 131 and the holder 303 in the X direction and the Y direction.

Thus, the light emitted from the light emitting element 211 of the printed substrate 301 can reach the light receiving element 212 along an intended optical path. As a result, the detection accuracy of the remaining amount of the toner 108 stored in the developer container 131 can be increased.

After the printed substrate 301 is attached to the holder 303, the push nuts 200 and 300 are respectively assembled to the bosses 206 and 304. The push nut 300 serves as a second fixing member. The push nuts 200 and 300 fix the printed substrate 301 to the holder 303 by restricting the printed substrate 301 from moving with respect to the holder 303 in the detachment direction DD.

That is, in the toner-remaining-amount detection sensor unit 330, the bosses 206 and 304 used for positioning the printed substrate 301 with respect to the holder 303 in the X direction and the Y direction are provided with the push nuts 200 and 300, and thereby the printed substrate 301 is fixed to the holder 303.

Thus, in the toner-remaining-amount detection sensor unit 330, the printed substrate 301 can be fixed to the holder 303 without using the hole and the screw used for fixing the printed substrate 301 to the holder 303, so that the printed substrate 301 can be downsized.

FIG. 7C is an enlarged view in which the boss 304 of the holder 303 inserted in the hole 302 of the printed substrate 301 in the toner-remaining-amount detection sensor unit 330 is viewed from above. As illustrated in FIG. 7C, in a case where the position of the center of the hole 302 in the X direction and the Y direction and the position of the center of the boss 304 in the X direction and the Y direction are made equal to each other, clearances 305 and 306 in the Y direction are formed between the inner circumference of the hole 302 and the outer circumference of the boss 304. The hole 302 of the printed substrate 301 and the boss 304 of the holder 303 are formed such that each of the clearances 305 and 306 is equal to or smaller than 0.5 mm.

With such a configuration, in the toner-remaining-amount detection sensor unit 330, the printed substrate 301 is restricted from moving with respect to the holder 303 in the X direction and the Y direction, so that the printed substrate 301 can be attached to the holder 303 with high accuracy.

As a result, in the toner-remaining-amount detection sensor unit 330, the light from the light emitting element 211 of the printed substrate 301 can travel along an intended optical path and reach the light receiving element 212, so that the amount of light necessary for the detection accuracy of the remaining amount of the toner 108 can be obtained.

In the toner-remaining-amount detection sensor unit 330, an increase of the undesired stray light that deviates from the optical path can be restricted, so that the deterioration of the detection accuracy of the remaining amount of the toner, caused by the stray light received by the light receiving element 212, can be restricted.

### Structure of Printed Substrate

FIG. 8 is a plan view of the printed substrate 301 of the second embodiment, viewed from the side of the surface 301a of the printed substrate 301 on which the light emitting element 211 and the light receiving element 212 are disposed.

In FIG. 8, a second substrate edge 307 of the printed substrate 301 is positioned, when viewed in the X direction from the light emitting element 211, on a side on which the light receiving element 212 is disposed, extending in parallel with the Y direction. A line 308 is an auxiliary line that passes through the light receiving element 212, and that is parallel with the second substrate edge 307.

In other words, the line 308 is a straight line that extends in the Y direction and that passes through the light receiving element 212. When viewed in the Z direction, the Y direction is orthogonal to the X direction in which the line L1 extends. The line L1 serves as an imaginary line that connects the light emitting element 211 and the light receiving element 212. The line 308 serves as a third straight line.

In the printed substrate 301, the light emitting element 211, the light receiving element 212, the hole 203, and the hole 302 are disposed on one side with respect to the line 214 in the Y direction. In the printed substrate 301, the hole 302 is disposed in an area A3 which is surrounded by the second substrate edge 307, the line 214, and the line 308, and in which a portion of the light receiving element 212 is included. In other words, when viewed in the Z direction, the hole 302 is disposed on the same side as the side on which the light emitting element 211, the light receiving element 212, and the hole 203 are disposed with respect to the line 214 in the Y direction, and is disposed on a side opposite to the light emitting element 211 with respect to the line 308 in the X direction.

In such a configuration, in the toner-remaining-amount detection sensor unit 330 of the second embodiment, the stray light from the light emitting element 211 can be attenuated by the time when the stray light reaches the hole portion 302a of the hole 302 on which no copper pattern is formed. Thus, in the toner-remaining-amount detection sensor unit 330, the amount of stray light that enters the printed substrate 301 from the hole portion 302a of the hole 302 and that is received by the light receiving element 212 is reduced. As a result, the deterioration of the detection accuracy of the toner-remaining-amount detection sensor unit 330 is reduced.

### Summary of Second Embodiment

As described above, in the printed substrate 301 of the second embodiment, the hole 302 in which no copper pattern can be formed on the hole portion 302a is disposed in the area A3. In other words, the printed substrate 301 includes the hole 302 positioned such that when viewed in the Z direction, the shortest distance between the light emitting element 211 and the hole 302 is longer than the shortest distance between the light emitting element 211 and the light receiving element 212. That is, in the printed substrate 301, the hole 302 is positioned such that when viewed in the Z direction, the hole 302 is closer to the light receiving element 212 than to the light emitting element 211.

In such a configuration, in the toner-remaining-amount detection sensor unit 330 of the second embodiment, the stray light from the light emitting element 211 can be attenuated by the time when the stray light reaches the hole portion 302a of the hole 302 on which no copper pattern is formed. Thus, in the toner-remaining-amount detection sensor unit 330, the amount of stray light that enters the printed substrate 301 from the hole portion 302a of the hole 302 and that is received by the light receiving element 212 is reduced. As a result, the deterioration of the detection accuracy of the toner-remaining-amount detection sensor unit 330 is reduced.

In the printed substrate 301, when viewed in the Z direction, the distance between the light emitting element 211 and the hole portion 302a is longer than the distance between the light emitting element 211 and the light receiving element 212 in the X direction.

In such a configuration, in the toner-remaining-amount detection sensor unit 330, the distance in which the stray light from the light emitting element 211 travels until the stray light reaches the hole portion 302a of the hole 302 on which no copper pattern is formed is longer than the distance between the light emitting element 211 and the light receiving element 212. Thus, in the toner-remaining-amount detection sensor unit 330, stray light that enters the printed substrate 301 from the hole portion 302a of the hole 302 is attenuated and the amount of stray light received by the light receiving element 212 is reduced. As a result, the deterioration of the detection accuracy of the toner-remaining-amount detection sensor unit 330 is reduced.

In the printed substrate 301 of the second embodiment, the hole 302 is disposed in the area A3 that is in the vicinity of the light receiving element 212. In the toner-remaining-amount detection sensor unit 330, the bosses 206 and 304 used for positioning the printed substrate 301 with respect to the holder 303 in the X direction and the Y direction are provided with the push nuts 200 and 300, and thereby the printed substrate 301 is fixed to the holder 303.

Thus, in the toner-remaining-amount detection sensor unit 330, the printed substrate 301 can be fixed to the holder 303 without using any component other than the components used for positioning the printed substrate 301 with respect to the holder 303. As a result, the printed substrate 301 can be downsized.

In the toner-remaining-amount detection sensor unit 330 of the second embodiment, in a case where the printed substrate 301 is separated from the holder 303, so as to float away from the holder 205, due to the warpage or the like of the printed substrate 201 in the Z direction, the center optical axis of the light receiving element 212 can be restricted from being shifted from the opening portion 210 of the holder 303. Thus, the toner-remaining-amount detection sensor unit 330 can restrict the reduction of the amount of light used for the light receiving element 212 to detect the remaining amount of the toner 108. In the toner-remaining-amount detection sensor unit 330, the light receiving element 212 and the emission end 253b (see FIG. 4) of the light guide 251 is restricted from being shifted in position from each other, and the light emitted from the emission end 253b is restricted from deviating from the optical path and becoming the stray light.

### Other Embodiments

Although the push nut 200 is disposed as the fixing member in the first and the second embodiments, the present disclosure is not so limited. For example, the fixing member may be a nut that is fit to threads formed in the boss 206. In another case, the fixing member may be a rivet that can be inserted into the boss 206. In this case, the printed substrate may be fixed to the holder by deforming the rivet. In another case, the fixing member may be an adhesive applied to the boss 206. In another case, the leading end of the boss 206 in the detachment direction DD may be made deformable. In this case, the printed substrate may be fixed to the holder by deforming the leading end of the boss 206.

Although the light emitting element 211 and the light receiving element 212 are disposed on one side of the line 214 in the Y direction in the first and the second embodiments, the present disclosure is not so limited. For example, the light emitting element 211 and the light receiving element 212 may be disposed on the line 214 in the Y direction. In another case, in the substrate, the light emitting element 211 may be disposed on one side of the line 214 in the Y direction, and the light receiving element 212 may be disposed on the other side of the line 214 in the Y direction.

In the first and the second embodiments, the hole 203 is disposed on one side on which the light emitting element 211 is disposed with respect to the line 214 in the Y direction. However, the present disclosure is not so limited. For example, the hole 203 may be disposed on the other side with respect to the line 214 in the Y direction.

In the first and the second embodiments, the amount of the toner 108 stored in the developer container 131 is detected by the toner-remaining-amount detection sensor unit that serves as a sensor and that includes the light emitting element 211 and the light receiving element 212. However, the present disclosure is not so limited. For example, the substrate unit may include a sensor in which a plurality of toner-remaining-amount detection portions is disposed in the developer container 131. In this case, the capacitance of each of the plurality of toner-remaining-amount detection portions changes in accordance with the remaining amount of toner stored in the developer container 131, and the sensor detects the remaining amount of toner by detecting the current determined by the capacitance between toner-remaining-amount detection portions.

In the first and the second embodiments, the hole, which is one of the hole and the boss, is included in the substrate, and the boss, which is the other of the hole and the boss, is included in the holder. However, the present disclosure is not so limited. For example, the boss, which is one of the hole and the boss, may be included in the substrate, and the hole, which is the other of the hole and the boss, may be included in the holder. In this case, the push nut has only to be attached to the boss included in the substrate.

In another case, the first engaging portion may be a through-hole portion that constitutes a through hole, and the second engaging portion may be a projection portion projecting from the attachment surface of the substrate and inserted in the through hole. In this case, the hole that serves as the first engaging portion may have a groove into which a fixing member can be inserted, the fixing member may be inserted into the groove, the fixing member may be fit in the first engaging portion and the second engaging portion, and thereby the first engaging portion and the second engaging portion may be engaged with each other and the substrate and the holder may be fixed to each other.

In the first and the second embodiments, the boss and the rib formed on the holder are integrally molded with the facing surface that faces the substrate. However, the present disclosure is not so limited. For example, the boss and the rib disposed on the holder may be members different from the facing surface that faces the substrate.

In the first and the second embodiments, the holder is attached to the developer container 131. However, the present disclosure is not so limited. For example, the holder may be formed integrally with the developer container 131.

In the first and the second embodiments, the substrate unit is attached to the developer container 131 that serves as a frame of the developing unit 130 of the process cartridge 109. However, the present disclosure is not so limited. For example, the substrate unit may be attached to the printer body 100A of the image forming apparatus 100. That is, the substrate unit may be disposed at any position as long as the light emitting element 211 and the light receiving element 212 are disposed on a side-surface of the developer container 131 opposite to a side surface facing the developing roller 107.

In the first and the second embodiments, the process cartridge 109 is included as a developing apparatus. However, the present disclosure is not so limited. For example, the process cartridge 109 may be divided into a drum cartridge that includes the photosensitive drum 105, and a developing cartridge that includes a storage portion storing toner and that is detachably supported by the drum cartridge. In this case, the developing cartridge serves as the developing apparatus.

The present disclosure can suppress the upsizing of the apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-044032, filed March 18, 2025, which is hereby incorporated by reference herein in its entirety.

What is claimed is:

1. A substrate unit comprising:
a sensor configured to output a signal that corresponds to an amount of toner stored in a storage portion configured to store the toner;
a substrate including the sensor and a hole;
a holder including a boss configured to be inserted into the hole, the holder being configured to hold the substrate; and
a push nut configured to position the substrate with respect to the holder,
wherein the push nut engages with the boss such that the substrate is disposed between the holder and the push nut.

2. The substrate unit according to claim 1, wherein the substrate includes an engaged portion,
wherein the holder includes an engaging portion configured to engage with the engaged portion, and
wherein the engaging portion is configured to restrict rotation of the substrate with respect to the holder around a rotation axis extending along a direction in which the boss extends.

3. The substrate unit according to claim 2, wherein the engaging portion and the boss are molded integrally with each other.

4. The substrate unit according to claim 1, wherein the substrate includes an engaged portion,
wherein the holder includes an engaging portion configured to engage with the engaged portion,
wherein the sensor includes a light emitting element configured to emit light toward an interior of the storage portion, and a light receiving element configured to receive the light emitted from the light emitting element and having passed through the interior of the storage portion,
wherein one of the engaging portion and the engaged portion is a rib, and
wherein the rib is disposed between the light emitting element and the light receiving element.

5. The substrate unit according to claim 4, wherein, when viewed in a direction in which the boss extends, a shortest distance between the hole and the light emitting element is shorter than a shortest distance between the hole and the light receiving element.

6. The substrate unit according to claim 1, wherein the sensor includes a light emitting element configured to emit light toward an interior of the storage portion, and a light receiving element configured to receive the light emitted from the light emitting element and having passed through the interior of the storage portion,
wherein, when viewed in a direction in which the boss extends, a line connecting the light emitting element and the light receiving element extends in a first direction,
wherein a second direction is orthogonal to both of the first direction and a normal direction perpendicular to a surface of the substrate,
wherein a first line extends in the first direction and passes through a center of the substrate in the second direction,
wherein a second line extends in the second direction and passes through the light emitting element,
wherein the light emitting element, the light receiving element, and the hole are disposed on one side of the first line in the second direction, and
wherein the hole is disposed on a side opposite to the light receiving element with respect to the second line in the first direction.

7. The substrate unit according to claim 1, wherein a clearance between the hole and the boss is equal to or smaller than 1 mm.

8. The substrate unit according to claim 1, wherein the hole is a first hole,
wherein the boss is a first boss,
wherein the substrate is provided with the first hole and a second hole,
wherein the holder includes the first boss and a second boss,
wherein the second boss is configured to be inserted into the second hole and restrict rotation of the substrate with respect to the holder around a rotation axis extending along a direction in which the first boss extends,
wherein the sensor includes a light emitting element configured to emit light toward an interior of the storage portion, and a light receiving element configured to receive the light emitted from the light emitting element and having passed through the interior of the storage portion, and
wherein, when viewed in a direction in which the first boss extends, a shortest distance between the second hole and the light receiving element is shorter than a shortest distance between the second hole and the light emitting element.

9. The substrate unit according to claim 8, wherein, when viewed in the direction in which the first boss extends, a line connecting the light emitting element and the light receiving element extends in a first direction, and a distance in the first direction from the light emitting element to the second hole is longer than a distance from the light emitting element to the light receiving element, when viewed in the direction in which the first boss extends.

10. The substrate unit according to claim 8, wherein the push nut is a first push nut, and
wherein the substrate unit further comprises a second push nut configured to engage with the second boss and restrict the substrate from separating from the holder in a direction in which the second boss extends.

11. The substrate unit according to claim 8, wherein the first boss and the second boss are molded integrally with each other.

12. The substrate unit according to claim 8, wherein the sensor includes a light emitting element configured to emit light toward the interior of the storage portion, and a light receiving element configured to receive the light emitted from the light emitting element and having passed through the interior of the storage portion, and
wherein, when viewed in a direction in which the first boss extends, a line connecting the light emitting element and the light receiving element extends in a first direction,
wherein a second direction is orthogonal to both of the first direction and a normal direction perpendicular to a surface of the substrate,
wherein a first line extends in the first direction and passes through a center of the substrate in the second direction,
wherein a second line extends in the second direction and passes through the light emitting element,
wherein a third line extends in the second direction and passes through the light receiving element,
wherein the light emitting element, the light receiving element, the first hole, and the second hole are disposed on one side of the first line in the second direction,
wherein the first hole is disposed on a side opposite to the light receiving element with respect to the second line in the first direction, and
wherein the second hole is disposed on a side opposite to the light emitting element with respect to the third line in the first direction.

13. An image forming apparatus comprising:
an apparatus body; and
the substrate unit according to claim 1, which is detachably attached to the apparatus body.
